(19) United States
(12) Patent Application Publication
(10) Pub. No.: US 2026/0202032 A1
(43) Pub. Date: Jul. 16, 2026

(54) VEHICLE EMERGENCY FLASHER CONTROL SYSTEM

(71) Applicant: NISSAN NORTH AMERICA, INC., Franklin, TN (US)

(72) Inventors: Corey HEATH, Scottsdale, AZ (US); Mark FISCHER, Santa Rosa, CA (US)

(21) Appl. No.: 19/026,295

(22) Filed: Jan. 16, 2025

(51) Int. Cl. F21S 43/00; B60Q 1/46; F21W 103/20; F21W 103/30

(52) U.S. Cl. CPC F21S 43/00; B60Q 1/46; B60Q 2900/30; F21W 2103/20; F21W 2103/30

(57) ABSTRACT

An emergency flasher control system for a host vehicle includes a plurality of sensors, a memory, and an electronic controller. The plurality of sensors is configured to detect information related to the host vehicle. The information includes a speed of the host vehicle and a location of the host vehicle. The memory is configured to store a plurality of events configured to activate an emergency flasher. The electronic controller is configured to determine a current jurisdiction in which the host vehicle is currently located, determine an emergency flasher requirement associated with the current jurisdiction, determine whether the information received from the plurality of sensors matches one of the stored plurality of events, activate an emergency flasher of the host vehicle upon determining that the received information matches one of the stored plurality of events, and preventing activation of the emergency flasher based on the jurisdictional requirement.

### BACKGROUND

### Technical Field

The present disclosure generally relates to a vehicle emergency flasher control system. More specifically, the present disclosure relates to activating an emergency flasher based on information related to a host vehicle.

### Background Information

Emergency flashers of a vehicle alert other vehicles that the vehicle activating the emergency flashers is in distress, needs to slow down to avoid road hazards or inclement weather, or has to make an emergency stop. Due to the stress associated with a situation in which emergency flashers are typically activated, a driver of the vehicle may not think to manually activate the emergency flashers. The likelihood of the driving neglecting to activate the emergency flashers during a high stress situation is even larger. The stress experienced by the driver can make it difficult for the driver to locate a button to activate the emergency flashers, particularly if the driver is operating an unfamiliar vehicle, such as a rental vehicle. To further complicate the use of emergency flashers, regulations regarding when to legally use the emergency flashers can vary from jurisdiction to jurisdiction.

### SUMMARY

A need exists for a vehicle emergency flasher control system configured to automatically control an emergency flasher of the vehicle.

In view of the state of the known technology, one aspect of the present disclosure is to provide an emergency flasher control system for a host vehicle including a plurality of sensors, a memory, and an electronic controller. The plurality of sensors is configured to detect information related to the host vehicle. The information includes a speed of the host vehicle and a location of the host vehicle. The memory is configured to store a plurality of events configured to activate an emergency flasher. The electronic controller is configured to determine a current jurisdiction in which the host vehicle is currently located, determine an emergency flasher requirement associated with the current jurisdiction, determine whether the information received from the plurality of sensors matches one of the stored plurality of events, activate an emergency flasher of the host vehicle upon determining that the received information matches one of the stored plurality of events, and preventing activation of the emergency flasher based on the jurisdictional requirement upon determining that the received information matches one of the stored plurality of events.

Also other objects, features, aspects and advantages of the disclosed vehicle emergency flasher control system will become apparent to those skilled in the art from the following detailed description, which, taken in conjunction with the annexed drawings, discloses exemplary embodiments of the vehicle emergency flasher control system.

### BRIEF DESCRIPTION OF THE DRAWINGS

Referring now to the attached drawings which form a part of this original disclosure, an illustrative embodiment is shown.

FIG. 1 is a schematic diagram of a host vehicle including an emergency flasher control system in accordance with an exemplary embodiment;

FIG. 2 is a schematic diagram of a communication system of the host vehicle of FIG. 1;

FIG. 3 is a perspective view of an instrument panel of the vehicle of FIG. 1;

FIG. 4 is an elevational view of the host vehicle of FIG. 1;

FIG. 5 is a flowchart illustrating an emergency flasher control system for the host vehicle of FIG. 1 based on traffic information;

FIG. 6 is a plan view of the traffic information based situation of FIG. 5;

FIG. 7 is a flowchart illustrating an emergency flasher control system for the host vehicle of FIG. 1 based on lane location information;

FIG. 8 is a plan view of the lane location based situation of FIG. 7;

FIG. 9 is a flowchart illustrating an emergency flasher control system for the host vehicle of FIG. 1 in a weather or terrain based situation;

FIG. 10 is flowchart illustrating the emergency flasher control system for the host vehicle of FIG. 1 based on rapid deceleration detection;

FIG. 11 is a plan view of the rapid deceleration situation of FIG. 10; and

FIG. 12 is a flowchart illustrating an emergency flasher control system for the host vehicle of FIG. 1 based on erratic driving information.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

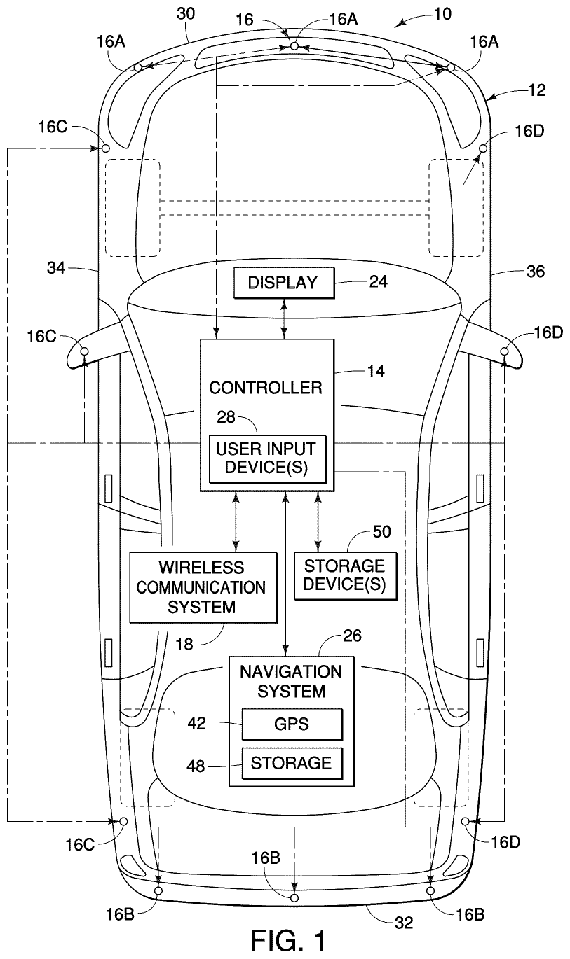

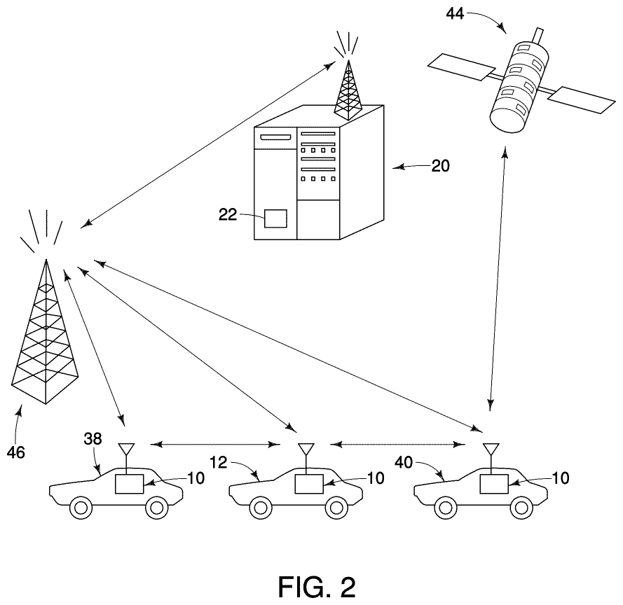

An emergency flasher control system 10 for the host vehicle 12 includes an electronic controller 14, a plurality of sensors 16, and a storage device, such as a memory, 50, as shown in FIG. 1. The emergency flasher control system further includes an external server 20, including a database 22, as shown in FIG. 2.

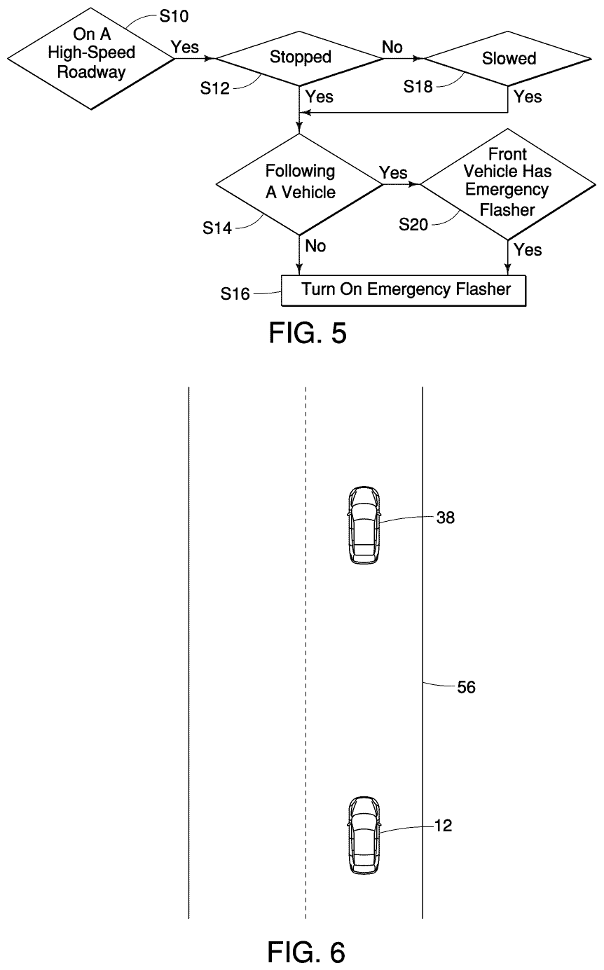

The electronic controller 14 preferably includes a microcomputer with a control program that controls the components of the emergency flasher control system 10 as discussed below. The electronic controller 14 includes other conventional components, such as an input interface circuit, an output interface circuit, and storage device(s), such as a ROM (Read Only Memory) device and a RAM (Random Access Memory) device. The microcomputer of the controller 14 is at least programmed to control the emergency flasher control system 10 in accordance with the flowcharts of FIGS. 5, 7, 9, 10 and 12 discussed below. The microcomputer of the controller 14 is programmed to control the plurality of sensors 16, a display 24, a navigation system 26, and a wireless communication system 18, and to make determinations or decisions, as discussed herein. The memory circuit stores processing results and control programs, such as ones for the plurality of sensors 16, the display 24, the navigation system 26, and the wireless communication system 18. The controller 14 is operatively coupled to the plurality of sensors 16, the display 24, the navigation system 26, and the wireless communication system 18 in a conventional manner, as well as other electrical systems in the host vehicle 12, such the turn signals, windshield wipers, lights and any other suitable systems. Such a connection enables the controller 14 to monitor and control any of these systems as desired. The internal RAM of the controller 14 stores statuses of operational flags and various control data. The internal ROM of the controller 14 stores the information for various operations. The controller 14 is capable of selectively controlling any of the components of the emergency flasher control system 10 in accordance with the control program. It will be apparent to those skilled in the art from this disclosure that the precise structure and algorithms for the controller 14 can be any combination of hardware and software that will carry out the functions of the exemplary embodiments of the present invention. Furthermore, the controller 14 can communicate with the other components of the vehicle communication system discussed herein via, for example a controller area network (CAN) bus or in any other suitable manner as understood in the art.

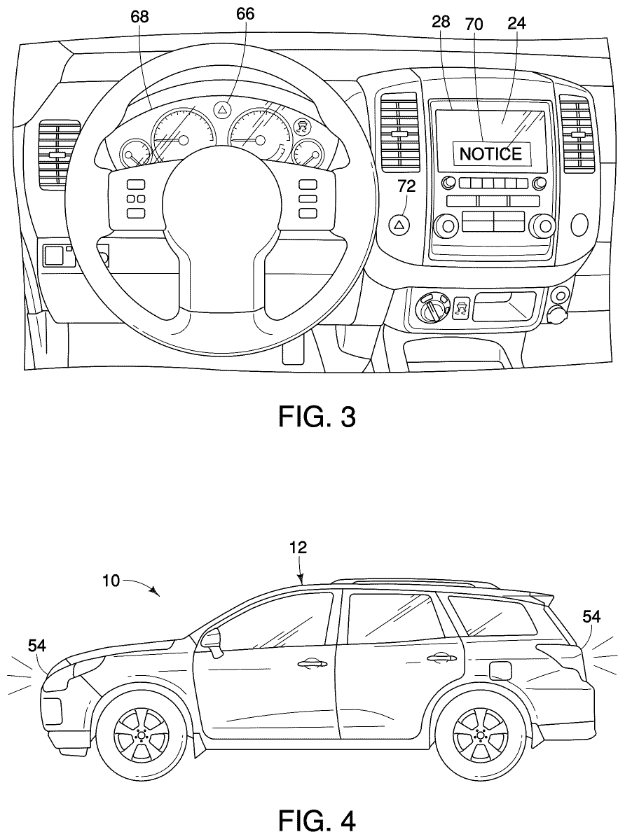

The controller 14 can include or be in communication with a user input device 28, as shown in FIGS. 1 and 3. The user input device 28 can include, for example, a human-machine interface (HMI), such as a control panel or a touchscreen graphical user interface (GUI), which enables a user (e.g., the driver and/or passenger) to interact with the emergency flasher control system 10 as understood in the art and discussed herein. The user input device 28 can be incorporated with the display 24 to facilitate interaction by a user. The controller 14 can further include or be in communication with one or more storage devices 50, such as a vehicle memory, that can store information as described herein.

In addition, the host vehicle 12 is equipped with the plurality of sensors 16 that can generate or capture vehicle environment information. In other words, the plurality of sensors 16 are configured to detect information related to the host vehicle 12. As shown in FIG. 1, four sensors 16A, 16B, 16C and 16D are provided, although any suitable number of sensors can be used. The plurality of sensors 16 include a front sensor 16A, a rear sensor 16B, a first, or driver's, side sensor 16C and a second, or passenger's, side sensor 16D. The front sensor 16A is preferably centrally located on a front bumper 30 of the vehicle 12. Additional front sensors 16A can be disposed on opposite ends of the front bumper 30. The rear sensor 16B is preferably centrally located on the rear bumper 32. Additional rear sensors 16B can be disposed on opposite ends of the rear bumper 32. The first side sensor 16C and the second side sensor 16D are disposed on the respective sides 34 and 36 of the vehicle 12, such as on an exterior side mirror or proximate a lower surface of the vehicle body structure beneath a door. Additional first and second side sensors 16C and 16D can be spaced along the respective sides 34 and 36 of the vehicle 12. Additional sensors 16 disposed on each side of the vehicle 12 increase the accuracy and coverage of obtaining the host vehicle information for the emergency flasher control system 10.

The at least one sensor 16 can be any of a plurality of differing types of sensors, often referred to as detection and ranging sensors or devices. The at least one sensor can be, but is not limited to, a depth camera, an ultrasonic sensor, a light detection and ranging (LiDAR) sensor, or a camera. Specifically, the at least one sensor 16 includes an emitting section (not shown) and a detecting section (not shown). The emitting section emits a prescribed signal and the detecting section detects returning signals that are reflected back from surfaces of nearby objects. Detection and ranging sensors are conventional devices, such that further description is omitted for the sake of brevity. A distance between a detected object, such as a preceding vehicle 38 (FIG. 6) or a following vehicle 40 (FIG. 8) and the host vehicle 12 is determined by the controller 14 using information detected by the plurality of sensors 16.

At least one sensor 16 is provided such that a distance between an object and the vehicle can be detected. Preferably, at least one sensor 16 is disposed at each of the sides 34 and 36 of the vehicle 12 to detect a distance between an object and a side of the vehicle 10. As shown in FIG. 2, the vehicle 12 can be provided with at least one sensor 16 on each of the four sides of the host vehicle 12 such that a distance between the vehicle and an object can be detected with respect to any side of the vehicle 12. The front sensor 16A, the rear sensor 16B, the first side sensor 16C, and the second side sensor 16D are sensors configured to detect the presence of the object and to measure and/or determine the distance between the detected object and the respective adjacent outer surface of the vehicle body structure as the vehicle body structure approaches the detected object. Each of the plurality of sensors 16 is configured to detect the distance between an object and the approaching respective outer surface of the vehicle 12 within a predetermined tolerance of, for example, plus-or-minus one inch (less than three centimeters). However, it should be understood that the tolerances can be greater or can be less, depending upon the size of the vehicle 10 and the specific type of sensor employed. The at least one sensor 16 is also configured to detect a speed of an object in the vicinity of the host vehicle 12.

The display 24 displays, for example, navigation information that indicates the location of the host vehicle 12 with respect to a map, as understood in the art. The display 24 can also display information related to operation of the emergency flasher control system 10 as set forth in the flowcharts of FIGS. 5, 7, 9, 10 and 12. The display 24 can incorporate the user input device 28, such as through a touchscreen, thereby allowing a user to interact with the emergency flasher control system 10.

The emergency flasher control system 10 of the host vehicle 12 can further include the vehicle navigation system 26, as shown in FIG. 1. The vehicle navigation system 26 includes, for example, a communication device 42, such as a GPS (Global Positioning System) communication device, that communicates with the GPS satellites 44. The communication device 42 can also communicate with one or more terrestrial units 46 and the base station or external server 20 to obtain location information and to communicate and receive emergency flasher information, as shown in FIG. 2. Furthermore, the emergency flasher control system 10 can include or is in communication with a storage device 48 that can store vehicle information, such as previous vehicle route information, location information, or other vehicle information that the GPS is capable of generating, in addition to map data and other location related data as understood in the art. The vehicle navigation system 26 can receive vehicle data from any suitable source, such as a remote device capable of connecting with the navigation system 26.

The emergency flasher control system 10 of the host vehicle 12 can further include the wireless communication system, or telematics control unit (TCU), 18. The wireless communication system 18 is a communication transceiver for performing a wireless communication with an external wireless communication device, as is understood in the art. The wireless communication system 18 can be configured for short-range wireless communication, such as Bluetooth, and/or for communication over a wireless network.

The emergency flasher control system 10, in accordance with exemplary embodiments of the present invention, automatically actives the emergency flasher 54 upon determining that the received information from the plurality of sensors 16 matches one of the plurality of events stored in the memory 50. The host vehicle 12 and other vehicles 38 and 40 equipped with the emergency flasher control system 10 obtain and transmit emergency flasher information to the server 20 while being operated on a road 56. The emergency flasher information includes information regarding emergency flasher regulations for the local jurisdiction in which the vehicle is currently traveling. The emergency flasher information can further include local conventions regarding use of emergency flashers.

Referring initially to FIG. 1, a two-way wireless communications network is illustrated that includes vehicle to vehicle communication and vehicle to base station communication. In FIG. 2, the host vehicle 12 is illustrated that is equipped with the emergency flasher control system 10 according to an exemplary embodiment of the present invention, and remote vehicles 38 and 40 that can also include the emergency flasher control system 10.

The emergency flasher control system 10 of the host vehicle 10 and the remote vehicles 38 and 40 communicate with the two-way wireless communications network. As shown in FIG. 2, for example, the two-way wireless communications network can include one or more global positioning satellites 44 (only one shown), and one or more roadside (terrestrial) units 46 (only one shown), and the base station or external server 20. The global positioning satellites 44 and the roadside units 46 send and receive signals to and from the emergency flasher control system 10 regarding emergency flasher information. The server 20 sends and receives signals to and from the emergency flasher control system 10 via a network of the roadside units 46, or any other suitable two-way wireless communications network.

The emergency flasher control system 10 automatically activates an emergency flasher 54 of the host vehicle 12, as shown in FIG. 4, in accordance with information detected by the plurality of sensors 16 and local jurisdiction requirements. As shown in FIG. 4, the host vehicle 12 preferably includes a plurality of emergency flashers 54 that are activated and deactivated in unison. The plurality of sensors 16 are configured to detect information related to the host vehicle 12, as shown in the flowcharts of FIGS. 5, 7, 9, 10 and 12. The information includes, but is not limited to, a speed of the host vehicle 12 and a location of the host vehicle 12.

The host vehicle 12 determines the local jurisdiction in which the host vehicle is currently traveling by GPS coordinates. The emergency flasher control system 10 can use the vehicle navigation system 26 to obtain location coordinates and compare to a map stored in the data storage 48 to determine the current jurisdiction in which the host vehicle 12 is currently located. Such information enables the emergency flasher control system 10 to determine the local jurisdiction, and to review a stored data table for the jurisdictional requirements regarding emergency flasher operation. That is, the emergency flasher control system 10 determines the location of the host vehicle 12, determines local jurisdiction in which the host vehicle 10 is currently traveling, and reviews a jurisdictional database saved in the data storage 50 to determine the jurisdictional requirements for emergency flasher operation. Alternatively, the jurisdictional database can be stored in a database 22 of the remote server 20 accessible through the wireless communication system 18. Alternatively, a local jurisdictional determination can be made in any suitable manner or can be input into the emergency flasher control system 10 by an operator through the user input device 28. Determining the current jurisdiction in which the host vehicle 12 is currently located and reviewing the jurisdictional database regarding the jurisdictional requirements for emergency flasher operation ensures compliance with local jurisdictional laws and rules regarding emergency flasher operation.

The electronic controller 14 of the emergency flasher control system 10 is configured to determine the current jurisdiction in which the host vehicle 12 is currently located. As shown in FIG. 6, the host vehicle 12 can use the vehicle navigation system 26 to determine the current jurisdiction in which the host vehicle 12 is currently located. The electronic controller 14 can then determine an emergency flasher requirement associated with the current jurisdiction. The electronic controller 14 further determines whether the information received from the plurality of sensors 16 matches one of the stored plurality of events, which are stored in the memory 50. Upon determining that the received information matches one of the plurality of stored events, the electronic controller 14 activates the emergency flasher 54, as shown in FIG. 4. The electronic controller 14 prevents activation of the emergency flasher 54 based on the jurisdictional requirement even upon determining that the received information is not within the jurisdictional requirement.

FIG. 5 illustrates a flowchart for emergency flasher operation by the emergency flasher control system 10 when the host vehicle 12 is traveling on a high-speed roadway. FIG. 5 illustrates the elements of one of the plurality of events stored in the memory 50. In step S10 of FIG. 5, the host vehicle 12 determines whether the host vehicle is traveling on a high-speed roadway 56, as shown in FIG. 6. This determination can be made in any suitable manner, such as through the vehicle navigation system 26 or by a sensor 16 detecting a speed limit sign.

Upon determining that the host vehicle 12 is currently traveling on a high-speed roadway 56, the electronic controller 14 determines whether the host vehicle 12 is stopped in step S12. Determining that the host vehicle 12 is stopped moves the process to step S14 to determine whether the host vehicle is following a vehicle 38. When the host vehicle 12 is stopped and not following the vehicle 38, the emergency flashers 54 are activated in step S16. This determination likely is indicative of the host vehicle 12 encountering a problem requiring the host vehicle 12 to stop, such that the emergency flasher 54 is activated to alert other vehicles on the high-speed roadway 56. The activation of the emergency flasher 54 is subject to the local jurisdictional requirements, which can prevent the activation of the emergency flasher when prohibited in this situation by the local jurisdictional requirements. In other words, the electronic controller 14 is configured to activate the emergency flasher 54 upon determining that the host vehicle is on the high-speed roadway 56 in step S10, that the host vehicle 12 is stopped in step S12, and that the host vehicle 12 is not following another vehicle 38 in step S14.

Upon determining that the host vehicle is not stopped in step S12, the electronic controller 14 determines whether the host vehicle 12 is slowed in step S18. Determining whether the vehicle is slowed can be based on whether the host vehicle 12 is traveling below the minimum speed limit, or can be defined as a predetermined percentage below the posted speed limit, such as 50-60% below the posted speed limit. Alternatively, whether the host vehicle 12 is slowed can be based on any suitable definition, such as determining the speeds of the other vehicles 38 surrounding the host vehicle 12 and determining whether the host vehicle is traveling a predetermined percentage, such as 30%, slower than an average speed of the surrounding vehicles, which is indicative of the host vehicle 12 impeding traffic. Alternatively, whether the host vehicle 12 is slowed can be determined when the host vehicle is traveling 20 miles per hour or more under the speed limit of the road currently being traveled. Alternatively, whether the vehicle is traveling too slowly can be legally defined by the local jurisdiction, such that the database 22 of the remote server 20 can be accessed to make this determination.

Upon determining that the host vehicle 12 is slowed, the process moves to step S14 to determine whether the host vehicle 12 is following a preceding vehicle 38. When the host vehicle 12 is determined to not be following the vehicle 38 in step S14, the emergency flasher 54 is activated in step S16. The activation of the emergency flasher 54 is subject to the local jurisdictional requirements, which can prevent the activation of the emergency flasher when prohibited in this situation by the local jurisdictional requirements. In other words, the electronic controller 14 is configured to activate the emergency flasher 54 upon determining that the host vehicle is on the high-speed roadway 56 in step S10, that the host vehicle 12 is slowed in step S18, and that the host vehicle 12 is not following another vehicle 38 in step S14.

Upon determining that the host vehicle 12 is following the vehicle 38 in step S14, as shown in FIG. 6, the electronic controller 14 determines whether the emergency flasher of the preceding vehicle 38 is activated. The information detected by the plurality of sensors 16 includes determining whether the emergency flasher of the preceding vehicle 38 is activated. Upon determining that the emergency flasher of the preceding vehicle 38 is flashing in step S20, the emergency flasher 54 of the host vehicle 12 is activated in step S16. The activation of the emergency flasher 54 is subject to the local jurisdictional requirements, which can prevent the activation of the emergency flasher when prohibited in this situation by the local jurisdictional requirements. In other words, the electronic controller 14 is configured to activate the emergency flasher 54 upon determining that the host vehicle is on the high-speed roadway 56 in step S10, that the host vehicle 12 is stopped in step S12 or slowed in step S18, that the host vehicle 12 is following another vehicle 38 in step S14, and that the emergency flasher of the another vehicle 38 is activated in step S20, which is one of the plurality of events stored in the memory 50.

As shown in FIG. 5, the information detected by the plurality of sensors 16 includes, but is not limited to, detecting whether the host vehicle 12 is on a high-speed roadway 56, whether the host vehicle 12 is stopped, whether the host vehicle 12 is following another vehicle 38, and whether the emergency flasher of the preceding vehicle 38 is activated.

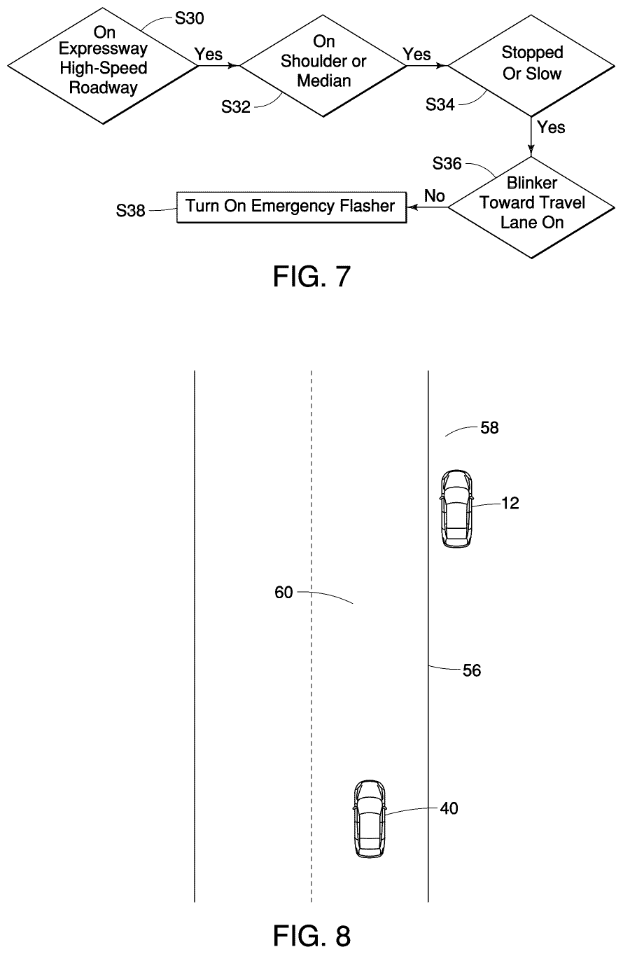

FIG. 7 illustrates a flowchart for emergency flasher operation by the emergency flasher control system 10 when the host vehicle 12 is traveling on the high-speed roadway 56. FIG. 7 illustrates the elements of one of the plurality of events stored in the memory 50. In step S30 of FIG. 7, the host vehicle 12 determines whether the host vehicle is traveling on a high-speed roadway 56, as shown in FIG. 8. This determination can be made in any suitable manner, such as through the vehicle navigation system 26 or by a sensor 16 detecting a speed limit sign.

The process moves to step S32 in which a determination is made whether the host vehicle 12 is currently located on a shoulder 58 or median of the roadway 56, as shown in FIG. 8. The plurality of sensors 16 determine the host vehicle 12 is located on the shoulder 58 or median of the roadway 56 in any suitable manner.

Upon determining that the host vehicle 12 is currently located on the shoulder 58 or median of the roadway 56 in step S32, the electronic controller 14 determines whether the host vehicle 12 is stopped or slowed in step S34. The plurality of sensors 16 determine whether the host vehicle is stopped or slowed in any suitable manner.

Upon determining that the host vehicle 12 is stopped or slowed in step S34, the electronic controller 14 determines whether a blinker, or turn signal, is activated indicating the intent of the host vehicle 12 to return to a traveling lane 60 of the roadway 56 in step S36. The electronic controller 14 determines whether the blinker is activated in any suitable manner.

Upon determining that the host vehicle 12 does not have a blinker activated in step S36, the process moves to step S38 in which the emergency flasher 54 is activated. The activation of the emergency flasher 54 is subject to the local jurisdictional requirements, which can prevent the activation of the emergency flasher when prohibited in this situation by the local jurisdictional requirements.

As shown in FIG. 7, the electronic controller 14 is configured to activate the emergency flasher 54 upon determining that the host vehicle is on the high-speed roadway 56 in step S30, that the host vehicle 12 is currently on the shoulder 58 or the median of the high-speed roadway 56, that the host vehicle 12 is either stopped or slowed, and that the turn signal of the host vehicle 12 indicative of re-entering the high-speed roadway 56 is not activated, which is one of the plurality of events stored in the memory 50.

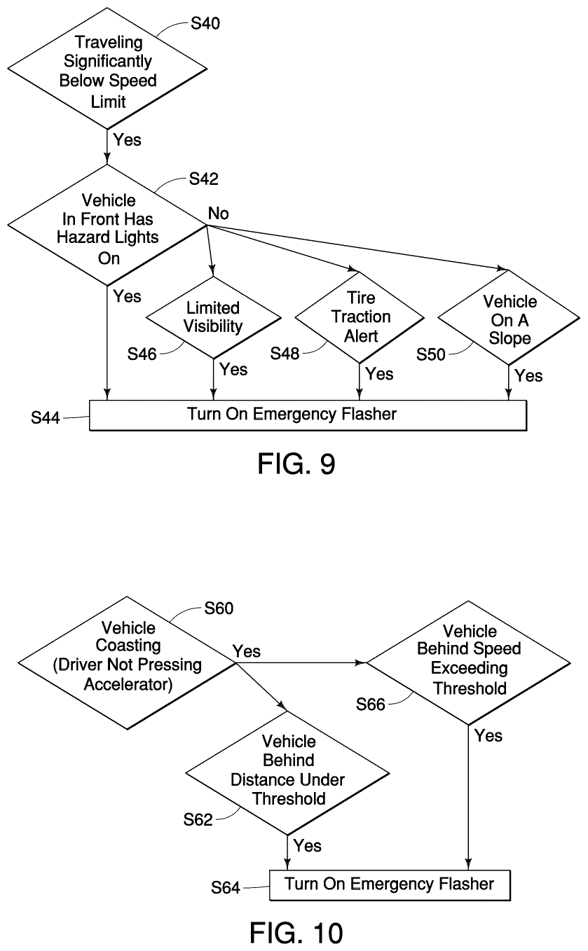

FIG. 9 illustrates a flowchart for emergency flasher operation by the emergency flasher control system 10 when the host vehicle 12 is determined to be traveling significantly below a speed limit. FIG. 9 illustrates the elements of one of the plurality of events stored in the memory 50. In step S40, the electronic controller 14 determines whether the host vehicle 12 is traveling significantly below the speed limit. Determining whether the host vehicle 12 is traveling significantly below the speed limit can be determined in any suitable manner, such as determining whether the host vehicle is traveling a predetermined percentage, or a predetermined amount, below the posted speed limit, such as 75% or greater below the posted speed limit.

Upon determining that the host vehicle 12 is traveling significantly below the speed limit in step S40, the process moves to step S42 in which a determination is made whether the vehicle 38 in front of the host vehicle 12 has the emergency flasher activated. When the preceding vehicle 38 in front of the host vehicle 12 is determined to have the emergency flasher activated in step S42, the process moves to step S44 in which the emergency flasher 54 is activated. The activation of the emergency flasher 54 is subject to the local jurisdictional requirements, which can prevent the activation of the emergency flasher when prohibited in this situation by the local jurisdictional requirements.

In step S42 of FIG. 9, when the preceding vehicle 38 (FIG. 6) does not have an emergency flasher activated or there is no preceding vehicle ahead of the host vehicle 12, the process moves to steps S46, S48 and S50 in which various conditions of the host vehicle 12 are determined that could cause the host vehicle to be traveling significantly below the speed limit.

In step S46 of FIG. 9, the electronic controller 14 determines whether the driver of the host vehicle 12 has limited visibility. Limited visibility can be defined as visibility less than 100 feet. Alternatively, limited visibility can be legally defined by the local jurisdiction, such that the database 22 of the remote server 20 can be accessed to facilitate making this determination. In step S48, the electronic controller 14 determines whether a tire traction alert is indicated, which is indicative of a tire slipping. In step S50, the electronic controller determines whether the vehicle is traveling on a slope. When any of steps S46, S48 and S50 are determined to be occurring, the process moves to step S44 in which the emergency flasher 54 is activated. Other mechanical issues with the host vehicle 12 can cause activation of the emergency flasher 54, such as, but not limited to, a sensor detecting a flat tire, a sensor detecting high engine temperature, and a sensor detecting low oil pressure. The activation of the emergency flasher 54 is subject to the local jurisdictional requirements, which can prevent the activation of the emergency flasher when prohibited in this situation by the local jurisdictional requirements.

As shown in FIGS. 6 and 9, the information detected by the plurality of sensors 16 includes, but is not limited to, detecting whether the emergency flasher of another vehicle 38 in front of the host vehicle 12 is activated. The electronic controller 14 is configured to activate the emergency flasher 54 upon determining that the host vehicle is traveling a predetermined amount below a speed limit of the roadway 56 upon which the host vehicle 12 is currently traveling, and that the emergency flasher of the vehicle 38 in front of the host vehicle 12 is activated, which is one of the events stored in the memory 50

As shown in FIGS. 6 and 9, the information detected by the plurality of sensors 16 includes, but is not limited to, detecting whether the emergency flasher of another vehicle 38 in front of the host vehicle 12 is activated. The electronic controller 14 is configured to activate the emergency flasher 54 upon determining that the host vehicle 12 is traveling a predetermined amount below a speed limit of the roadway 56 upon which the host vehicle 12 is currently traveling, that the emergency flasher of the vehicle 38 in front of the host vehicle 12 is not activated, and that the information received from the plurality of sensors 16 indicates at least one of limited visibility, a tire traction alert, and the host vehicle currently traveling on an inclined surface, which are events stored in the memory 50.

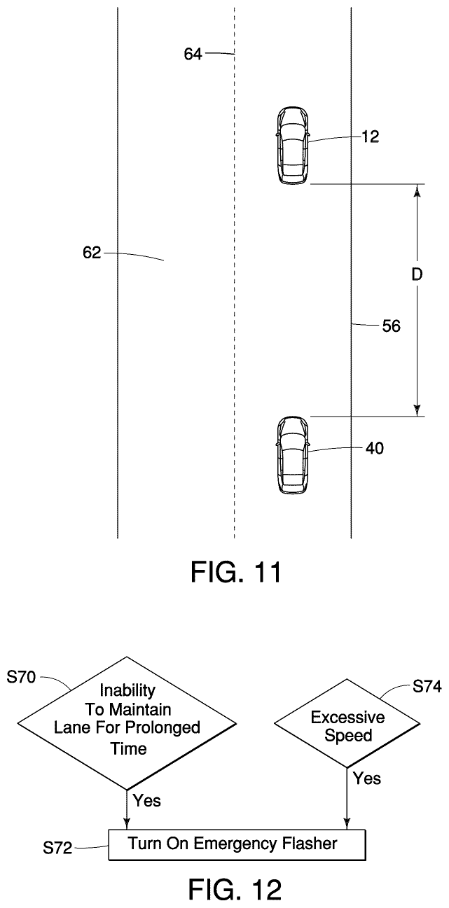

FIG. 10 illustrates a flowchart for emergency flasher operation by the emergency flasher control system 10 in which the host vehicle 12 is an electric vehicle including one-pedal driving. FIG. 10 illustrates the elements of one of the plurality of events stored in the memory 50. In step S60, a determination is made whether the host vehicle 12 is coasting. In other words, the electronic controller 14 determines whether the driver is pressing the accelerator pedal. Upon determining that the host vehicle 12 is coasting, the process moves to steps S62 and S66 to determine a condition of a following vehicle 40, as shown in FIG. 11. Steps S62 and S66 are directed to a following vehicle 40 behind the host vehicle 12, as shown in FIG. 11. Preferably, the following vehicle 40 is determined to be in the same lane 60 of the roadway 56, although the following vehicle 40 can also be in a different lane 62 from the host vehicle 12. The emergency flasher 54 of the host vehicle 12 is activated to alert the driver of the following vehicle 40, such that the emergency flasher 54 can be activated to alert the driver of the following vehicle 40 in a different lane 62 to the presence of the host vehicle 12.

In step S62 of FIG. 10, the electronic controller determines whether the following vehicle 40, or the vehicle behind the host vehicle, is a distance behind the host vehicle 12 that is less than a predetermined threshold. Whether the following vehicle 40 is closer than a predetermined threshold to the host vehicle 12 can be determined in any suitable manner. The following vehicle 40 is determined to be less than a predetermined threshold from the host vehicle 12 when the following vehicle 40 is less than a predetermined distance behind the host vehicle 12. The sensors 16 determine the speeds of the host vehicle 12 and the following vehicle 40 and a distance D between the host vehicle 12 and the following vehicle 40. The following vehicle 40 is beneath the predetermined threshold when the distance D between the host vehicle 12 and the following vehicle 40 is less than 3.0 seconds times the speed of the following vehicle 40 (i.e., 3.0 seconds×speed of following vehicle (m/s)). Alternatively, the following vehicle 40 is determined to be less than a predetermined threshold to the host vehicle 12 when the time between the host vehicle 12 and the following vehicle 40 is less than a predetermined time from the host vehicle 12. The following vehicle 40 is less than the predetermined time behind the host vehicle 12 when the time between the host vehicle 12 and the following vehicle 40 is less than the sum of eight seconds plus the distance between the host vehicle and the following vehicle divided by speed of the following vehicle 40 (i.e., 8.0 seconds+(distance between vehicles (m)/speed of following vehicle (m/s))). Any other suitable method can be used to determine whether the following vehicle 40 is rapidly approaching the host vehicle 12. The emergency flasher control system 10 activates the emergency flasher 54, when permitted by the jurisdictional requirements, when the following vehicle 40 is determined to be rapidly approaching the host vehicle 12. The flowchart of FIG. 10 is equally applicable to vehicles other than an electric vehicle equipped with one pedal driving. When the following vehicle 40 behind the host vehicle 12 is determined to be closer than a predetermined threshold in step S62, the process moves to step S64 in which the emergency flasher 54 is activated. The activation of the emergency flasher 54 is subject to the local jurisdictional requirements, which can prevent the activation of the emergency flasher when prohibited in this situation by the local jurisdictional requirements.

In step S66 of FIG. 10, the electronic controller 14 determines whether a speed of the following vehicle 40, or the vehicle behind the host vehicle 12, is exceeding a predetermined threshold. Whether the speed of the following vehicle 40 is excessive can be determined in any suitable manner. The speed of the following vehicle 40 can be determined to be excessive when the speed of the following vehicle 40 is a predetermined amount over the speed limit, such as, but not limited to, 40 miles per hour or greater than the posted speed limit. When the speed of the following vehicle 40 behind the host vehicle 12 is determined to be exceeding the predetermined threshold in step S66, the process moves to step S44 in which the emergency flasher 54 is activated. The activation of the emergency flasher 54 is subject to the local jurisdictional requirements, which can prevent the activation of the emergency flasher when prohibited in this situation by the local jurisdictional requirements.

As shown in FIGS. 10 and 11, the information detected by the plurality of sensors 16 includes, but is not limited to, detecting whether a pedal of the host vehicle 12 is being pressed in step S60, the speed of the another vehicle 40 behind the host vehicle 12 in step S66, and the distance D between the host vehicle 12 and the another vehicle 40 in step S62. The electronic controller 14 is configured to activate the emergency flasher 54 upon determining that the pedal (i.e., the accelerator pedal) of host vehicle 12 is not being pressed in step S60, and that the distance between the host vehicle 12 and the another vehicle 40 is less than a predetermined amount in step S62, which is an event stored in the memory 50.

As shown in FIGS. 10 and 11, the information detected by the plurality of sensors 16 includes, but is not limited to, detecting whether a pedal of the host vehicle 12 is being pressed in step S60, the speed of the another vehicle 40 behind the host vehicle 12 in step S66, and the distance D between the host vehicle 12 and the another vehicle 40 in step S62. The electronic controller 14 is configured to activate the emergency flasher 54 upon determining that the pedal (i.e., the accelerator pedal) of host vehicle 12 is not being pressed in step S60, and that the speed of the another vehicle 40 is larger than a predetermined amount in step S66, which is an event stored in the memory 50.

The event illustrated in FIG. 10 is directed to an electric vehicle that implements regenerative braking while coasting. A coasting electric vehicle decelerates more rapidly than an internal combustion engine vehicle, and does not cause the brake lights to illuminate. The event illustrated in FIG. 10 automatically activates the emergency flasher 54 to alert the following vehicle 40 to the coasting electric vehicle.

FIG. 12 illustrates a flowchart for emergency flasher operation by the emergency flasher control system 10 in which the host vehicle 12 is being operated erratically. FIG. 12 illustrates the elements of one of the plurality of events stored in the memory 50. In step S70, a determination is made whether the host vehicle 12 is unable to maintain a position within a lane 60, as shown in FIG. 11, for a predetermined amount of time. Whether the host vehicle is unable to maintain a position within the lane 60 for a predetermined amount of time can be determined in any suitable manner by the sensors 16. The predetermined amount of time can be any suitable amount of time, such as, but not limited to, sixty seconds. Whether the host vehicle 12 is driving erratically can be determined when the vehicle is detected to change lanes a predetermined number of times, such as between at least seven to ten times, within a predetermined amount of time, such as sixty seconds. Alternatively, whether the host vehicle is driving erratically can be determined when the host vehicle receives a predetermined number of out of lane warnings, such as between at least three to five warnings, within a predetermined amount of time, such as sixty seconds. Upon determining that the host vehicle 12 is unable to maintain a position within the lane for the predetermined amount of time in step S70, then the process moves to step S72 in which the emergency flasher 54 is activated. In other words, upon determining that the host vehicle 12 repeatedly crosses the center line 64 or repeatedly moves between the lane 60 and the adjacent lane 62 during the predetermined amount of time, the emergency flasher 54 is activated. The activation of the emergency flasher 54 is subject to the local jurisdictional requirements, which can prevent the activation of the emergency flasher when prohibited in this situation by the local jurisdictional requirements.

As shown in FIG. 12, the information further includes whether the host vehicle 12 is being maintained within the lane 60 of the roadway 56 currently being traveled. The electronic controller 14 is configured to activate the emergency flasher 54 upon determining that the host vehicle 12 is not being maintained within the lane for at least a predetermined amount of time.

In step S74 of FIG. 12, the electronic controller 14 determines whether the host vehicle is traveling at an excessive speed. Whether the host vehicle 12 is traveling at an excessive speed can be determined in any suitable manner. Excessive speed can be determined when the host vehicle 12 travels at a speed equal to or larger than a predetermined amount over the speed limit for a predetermined amount of time. The predetermined amount over the speed limit can be, but is not limited to, 40 miles per hour or more over the speed limit. The predetermined amount of time can be, but is not limited to, two minutes. Upon determining that the host vehicle 12 is traveling at an excessive speed in step S74, the process moves to step S72 in which the emergency flasher 54 is activated. The activation of the emergency flasher 54 is subject to the local jurisdictional requirements, which can prevent the activation of the emergency flasher when prohibited in this situation by the local jurisdictional requirements.

As shown in FIG. 12, the electronic controller 14 is configured to activate the emergency flasher upon determining that the speed of the host vehicle 12 is a predetermined amount over a speed limit of the roadway currently being traveled, which is an event stored in the memory 50.

Prior to automatically activating the emergency flasher 54, as shown in the flowcharts of FIGS. 5, 7, 9, 10 and 12, the electronic controller 14 determines whether the local jurisdictional requirements prohibit activation of the emergency flasher in the current situation. When activation of the emergency flasher 54 is prohibited by the local jurisdictional requirements, activation of the emergency flasher 54 is prevented by the electronic controller 14, even when the emergency flasher control system 10 determines that the emergency flasher should be activated. When activation of the emergency flasher 54 is not prohibited by the local jurisdictional requirements, the electronic controller 14 activates the emergency flasher 54. The local jurisdictional requirements can be stored in the memory, or storage device, 50 of the host vehicle 12. Alternatively, the host vehicle 12 can communicate with a remote server 20, as shown in FIG. 2, to obtain the local jurisdictional requirements stored in the database 22 of the remote server.

When the emergency flasher control system 10 activates the emergency flasher 54, the emergency flasher 54 remains activated as the flowchart cycles through the steps. When the emergency flasher control system 10 determines that the received information no longer matches the stored event, the emergency flasher 54 is deactivated. Alternatively, an emergency flasher button 72, as shown in FIG. 3, can be manually pressed to deactivate, or turn off, the emergency flasher 54.

When the emergency flasher control system 10 activates the emergency flasher 54, an indicator 66, such as in an instrument panel 68, is illuminated to indicate activation of the emergency flasher, as shown in FIG. 3. A notification 70 can be displayed, such as on the display 28, indicating an event resulting in activation of the emergency flasher 54. The notification 70 can describe the event, such as determining that the vehicle is being driven erratically by traveling at an excessive speed in step S74 in FIG. 12, causing activation of the emergency flasher 54. Pressing the emergency flasher button 72 deactivates the activated emergency flasher 54. Pressing the emergency flasher button 72 activates the emergency flasher 54 when the emergency flasher 54 is not currently activated.

The emergency flasher control system 10 automatically actives the emergency flasher 54 when the received information from the plurality of sensors 16 matches one of the plurality of stored events in the memory 50, such that the user does not have to remember to manually activate the emergency flasher. The emergency flasher 16 is prevented from being activated, even when the received information matches one of the plurality of stored events, when activation of the emergency flasher is not allowed by the local jurisdictional requirement.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle equipped with the emergency flasher control system. Accordingly, these terms, as utilized to describe the present invention should be interpreted relative to a vehicle equipped with the emergency flasher control system.

The term “detect” as used herein to describe an operation or function carried out by a component, a section, a device or the like includes a component, a section, a device or the like that does not require physical detection, but rather includes determining, measuring, modeling, predicting or computing or the like to carry out the operation or function.

The term “configured” as used herein to describe a component, section or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the vehicle field from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. An emergency flasher control system for a host vehicle, the system comprising:
a plurality of sensors configured to detect information related to the host vehicle, the information including a speed of the host vehicle and a location of the host vehicle; and
a memory configured to store a plurality of events configured to activate an emergency flasher; and
an electronic controller configured to
determine a current jurisdiction in which the host vehicle is currently located;
determine an emergency flasher requirement associated with the current jurisdiction;
determine whether the information received from the plurality of sensors matches one of the stored plurality of events, and
activate the emergency flasher of the host vehicle upon determining that the received information matches one of the stored plurality of events; and
prevent activation of the emergency flasher based on the jurisdictional requirement upon determining that the received information matches one of the stored plurality of events.

2. The system according to claim 1, wherein
the information further includes detecting whether the vehicle is on a high-speed roadway, whether the vehicle is stopped, and whether the vehicle is following another vehicle.

3. The system according to claim 2, wherein
one of the plurality of stored events configured to activate the emergency flasher includes
the host vehicle being on the high-speed roadway,
the host vehicle being stopped, and
the host vehicle not following the another vehicle.

4. The system according to claim 2, wherein
one of the plurality of stored events configured to activate the emergency flasher includes
the host vehicle being on the high-speed roadway,
the host vehicle being slowed, and
the host vehicle not following the another vehicle.

5. The system according to claim 2, wherein
one of the plurality of stored events configured to activate the emergency flasher includes
the host vehicle being on the high-speed roadway,
the host vehicle being stopped or slowed,
the host vehicle following the another vehicle, and
the emergency flasher of the another vehicle being activated.

6. The system according to claim 2, wherein
one of the plurality of stored events configured to activate the emergency flasher includes
the host vehicle being on the high-speed roadway,
the host vehicle being on a shoulder or median of the high-speed roadway,
the host vehicle being either stopped or slowed, and
a turn signal of the host vehicle indicative of re-entering the high-speed roadway not being activated.

7. The system according to claim 1, wherein
the information further includes whether an emergency flasher of another vehicle in front of the host vehicle is activated, and
one of the plurality of stored events configured to activate the emergency flasher includes
the host vehicle traveling a predetermined amount below a speed limit of a roadway upon which the host vehicle is currently traveling, and
the emergency flasher of the another vehicle in front of the host vehicle being activated.

8. The system according to claim 1, wherein
the information further includes whether an emergency flasher of another vehicle in front of the host vehicle is activated, and
one of the plurality of stored events configured to activate the emergency flasher includes
the host vehicle traveling a predetermined amount below a speed limit of a roadway upon which the host vehicle is currently traveling,
the emergency flasher of the vehicle in front of the host vehicle not being activated, and
the information received from the plurality of sensors indicates at least one of limited visibility, a tire traction alert, and the host vehicle currently traveling on an inclined surface.

9. The system according to claim 1, wherein
the host vehicle is an electric vehicle including one-pedal driving.

10. The system according to claim 9, wherein
the information further includes whether a pedal of the host vehicle is being pressed, a speed of another vehicle behind the host vehicle, and a distance between the host vehicle and the another vehicle.

11. The system according to claim 10, wherein
one of the plurality of stored events configured to activate the emergency flasher includes
the pedal of the host vehicle not being pressed, and
the distance between the host vehicle and the another vehicle being less than a predetermined amount.

12. The system according to claim 10, wherein
one of the plurality of stored events configured to activate the emergency flasher includes
the pedal of the host vehicle not being pressed, and
the speed of the another vehicle being larger than a predetermined amount.

13. The system according to claim 1, wherein
one of the plurality of stored events configured to activate the emergency flasher includes the speed of the host vehicle being a predetermined amount over a speed limit of the roadway currently being traveled.

14. The system according to claim 1, wherein
the information further includes whether the host vehicle is being maintained within a lane of the roadway currently being traveled, and
one of the plurality of stored events configured to activate the emergency flasher includes the host vehicle not being maintained within the lane for at least a predetermined amount of time.

15. The system according to claim 1, wherein
determining whether the current jurisdiction defines the predetermined threshold, and
using the predetermined threshold defined by the current jurisdiction instead of the predetermined threshold stored in the memory.

16. The system according to claim 1, wherein
an indicator is illuminated indicating activation of the emergency flasher.

17. The system according to claim 1, wherein
a notification is displayed indicating an event resulting in activation of the emergency flasher.

18. The system according to claim 1, wherein
the memory stores emergency flasher requirements associated with a plurality of jurisdictions.

19. The system according to claim 1, wherein
the host vehicle is configured to communicate with a remote server to determine the emergency flasher requirement associated with the current jurisdiction.

20. The system according to claim 1, wherein
pressing a button of the host vehicle deactivates the activated emergency flasher.
